(19) United States
(12) Patent Application Publication
(10) Pub. No.: US 2010/0224714 A1
(43) Pub. Date: Sep. 9, 2010

(54) CORD ADJUSTMENT DEVICE

(75) Inventors: Isak Winther, Reykjavik (IS); Petur Gudmundsson, Seltjarnarnes (IS)

Correspondence Address: CANTOR COLBURN, LLP, 20 Church Street, 22nd Floor, Hartford, CT, 06103, US

(73) Assignee: PREGGIONI EHF, Reykjavik (IS)

(21) Appl. No.: 12/682,678

(22) PCT Filed: Oct. 13, 2008
(86) PCT No.: PCT/IS2008/000016

§ 371 Date: May 11, 2010

(30) Foreign Application Priority Data
Oct. 12, 2007 (IS) 8682

(51) Int. Cl. B65H 75/44; B65H 75/14; H04M 1/15; H02G 11/02

(52) U.S. Cl. 242/400.1; 242/406

(57) ABSTRACT

The present invention provides a cord adjustment device for adjusting and managing the additional length of the cord of earphones when being used with portable multi-media devices such as a music player. The cord adjustment device is a spool shaped piece comprising magnetic material and further comprising a mating member which has a magnetic attraction to the spool member. The cord adjustment device is attached to clothing by placing the mating member on the reverse side of the clothing and the spool member on the outer side of the clothing. The cord adjustment device may also comprise a microphone, transmitter/receiver or an audio player.

### TECHNICAL FIELD

The present invention relates to a device for adjusting the length of an earphone cord and preventing the cord from getting tangled during use of a set of earphones plugged to a multimedia device.

### BACKGROUND OF THE INVENTION

The increasing use of mobile multimedia devices such as mp3 players, which require headphones or earphones, has pushed for solutions of managing the cord of the earphones. Although long headphone cords are advantageous when the user is sitting down or lying down at home or at work close to an in audio system, with the headphone jack several feet away, they are not as ease to manage when the user is in motion using handheld lightweight audio systems such as MP3 players. The music players are frequently used by people when exercising, either running or training in gyms, or just when performing daily routines at home or at work.

The common problem in all these instances is that the cord has the tendency of getting tangled up or getting caught in the user or nearby objects and thereby hindering the user to perform activities while listening to audio content.

Several solutions have been suggested and marketed such as the “smartwrap” or smarter-wrap solutions. These solutions have a common way of managing, shortening or optimising the length of earphone cords by a snap-wrap-snap method. This means that the cord is clipped onto one end of a plastic or silicon piece and then the excess length is wrapped around the centre portion of the device. When a desired length is obtained, the cord is clipped into the other end of the device. The Cable Turtle is a similar concept where the cable is wrapped around a rubber like yo-yo as the in an opened position and then the outer portions are folded back closing the device and securing the cable and collecting the additional length within the device.

The problem of organising the excess length of the cord in this manner is that the weight of the excess cord length as well as the weight of the device is collected into one point and this will bring a pulling force to the earphone. This means that a constant downwards pulling force is applied to the earphones which will disturb the user while doing activities while listening to audio content or even pull the earphones out of the ears.

Another solution for shortening long cords is lightweight sealable bags (bobbins) for holding the extra length. These are made from plastic cord manager and works better with thin headphone cords and are provided with a belt clip in order to attach to the upper arm for example.

### SUMMARY OF THE INVENTION

The present invention provides a wire management or cord adjustment device for adjusting or managing the length of the cord/wire of earphones when being used with portable multimedia device such as a music player. The present invention solves the problem of managing the additional length of long earphone cords without clipping the device onto an arm or other part of the body or forming a bundle, which pulls the earplugs downwards by a collected weight in one point.

The device of the present invention is a spool or reel shaped piece for adjusting cord length of earphone cords or managing the extra length of earphone cords when such cords are used with multimedia devices. The device further comprises magnetic material in on portion of the spool or reel shaped piece. A mating member is also provided having a magnetic attraction to the spool member and the device can thereby be attached to clothing by placing the mating member on the body side of the clothing and the spool member on the outer side of the clothing. Magnetic attachment of a button like device for attaching/securing to any clothing (sport/jacket). The button like device can have a fashion value, be a technical solution, completely wireless or for connecting to a transmitter or earphone cord.

In a first aspect of the present invention the cord adjustment device comprises a spool member, which further comprises a central axial portion having a first distal end and a second distal end, a front portion extending of the front/first distal end of the central axial portion having a larger circumference than the central axial portion, and a back portion extending of the back/second distal end of the central axial portion having a larger circumference than the central axial portion. The shape of the device is such that a cord can be “enwrapped” around the central portion of the spool member between the front and the back portion and a slot is formed in the front portion to receive the cord after it has been enwrapped around the central portion and fasten. The device is further characterised in that the back portion further comprises a magnetic material to attach the spool member to a magnetic surface.

In a second aspect of the present invention a dimensioned “device” configured for use with an earphone cord of a portable media device, such as compact disk players, mp3 players, iPOD's etc.

In a third aspect of the present invention, a method is provided for managing an earphone cord to be used with portable audio devices. The method comprises attaching the device of the present invention to clothing by placing the spool member on the outside of the clothing and the mating member on the body side of the clothing. The earphone cord is wrapped one or more times around the central axial portion of the spool member and then through the slot on the front portion of the spool member to fasten the cord. Thereby the excess length of the earphone cord is managed and the length and the position of the cord from the earplugs to the portable audio device is determined.

In a fourth aspect of the present invention the cord adjustment device comprises a spool member, including a central axial portion, a front portion extending of the front/first distal end of the central axial portion having a larger circumference than the central axial portion and a back portion extending of the back/second distal end of the central axial portion having a larger circumference than the central axial portion. This cord adjustment device is characterised in that a cord can be “enwrapped” around the central portion of the spool member and a slot is formed in the front member to receive the cord after it has been enwrapped around the central portion to secure the cord. The device is further characterised in that the back portion comprises a magnetic materiel to attach said spool member to a magnetic surface and that cord adjustment device further comprises a communication and/or connection portion for enabling cordless/wireless communication.

### DESCRIPTION OF THE INVENTION

In an embodiment of the present invention the cord adjustment or cord managing device comprises a spool (or reel) member, the spool member further comprises a central axial portion, a front portion having a larger circumference than the central axial portion, and a back portion having a larger circumference than the central axial portion. A slot is formed in the front member to receive the cord after it has been enwrapped around the central portion and the back portion further comprises a magnetic materiel to attach said spool member to a magnetic surface. The device further comprises a mating member comprising a magnetic material, configured to mate with the magnetic back portion. By placing the spool member on the outside of the clothing and the mating member on the body side of the clothing, the magnetic attraction of the two members will hold them together and the exact position of the device in the clothing can easily be determined and changed.

In an embodiment of the present invention the back portion of the spool member and the mating member may comprise a ferromagnetic materiel. The relationship between the back portion of the spool member with respect to the magnetic attraction is therefore dependent on the type of material, magnetic or ferromagnetic in the spool member and the mating member

In an embodiment of the present invention the cross-section of the spool member can be circular or non-circular. The shape of the cross-section of the front portion of the spool member determines the front view of the device of the present invention. An image or shape may be formed or printed onto the front portion of the spool member to represent a firm or an association, team or club etc. Technology such as “sticker printing” or “silkscreen printing” may be used to print images on the front portion of the device of the present invention, but other printing techniques (not listed here) are not excluded. In this context the spool member may further comprises a cover portion which can be attached and detached from the front portion of the spool member. This cover portion can be transparent in order to display a label attached to the front portion or a shape or printed matter on the front portion.

In an embodiment of the present invention, the front portion of the cord adjustment device may be labelled to display a logo, pattern, colour or image directly or through a transparent cover portion. Furthermore, stickers can be designed to be attached to the front portion of the cord adjustment device. The stickers can be made, where with glue, on the back side of the sticker is adhesive or semi-adhesive glue or the like resulting in a permanent or non-permanent sticker, where the sticker can be removed and re-attached several times. Stickers which attach to even/smooth surfaces through electrical charges/static energy can also be used with the device of the present invention.

In an embodiment of the present invention the cord adjustment device comprises a communication and/or connection portion. This embodiment is useful for cordless or wireless communication to and/or from the device. Communication devices such as, but not limited to a microphone, Bluetooth, a transmitter, a receiver and a transceiver (fm, IR or any other) can be incorporated into the cord adjustment device.

In an embodiment of the present invention the cord adjustment device comprises control buttons for controlling media devices comprised in the cord adjustment device comprises such as media devices of any kind.

In the present context the term “spool member” refers to an object which has a the shape of a spool or reel. The shape of the spool member is desirable for wrapping or winding a wire or cable or cord around it much like winding a cable around a winch.

In the present context the term “transmitting unit” refers to a unit for communication of signals from a microphone for example to a receiver unit.

In an embodiment of the present invention the cord adjustment device comprises a plug for plugging in ear-phones, and cables connecting the device to a transmitter, receiver or a transceiver.

In a specific embodiment of the present invention the cord adjustment device has a microphone and a transmitting unit. This allows the user to attach a microphone to his/hers clothing and the sound is then transmitted in a wireless manner to a receiver for amplification and to speakers. In another embodiment the cord adjustment device can include both a microphone and a mini-jack. In this embodiment the sound detected by the microphone is sent to a transmitter on the user via a wire coupled to the mini-jack.

In a further embodiment the cord adjustment device has a microphone, a transmitter and a mini-jack for operating with a mobile communication device (such as a mobile phone. The ear-phones for the user are then coupled to the mini-jack and the microphone is used for talking on the phone. The sound detected by the microphone is then transmitted in a wireless manner to a receiver through the transmitter.

In the present context, the term “earphone” relates to devices such as earphones, head phones and similar audio headsets for connecting to audio devices such as compact disk players and mp3 players in order to listen to audio content in private, i.e. without using loud speakers.

The present invention will now be described with respect to the drawings using reference numbers for indicating the different parts of the device.

### LIST OF DRAWINGS

FIG. 1 is a side view of the cord adjustment device of the present invention.

FIG. 2 is a top view of the cord adjustment device of the present invention.

FIG. 3 is perspective view showing the dimensions of the device.

FIG. 4 is a cross-section view of the cord adjustment device of the present invention.

FIG. 5 is a perspective view of the cord adjustment device including a microphone.

FIG. 6 is a perspective view of the cord adjustment device including mini-jack connector.

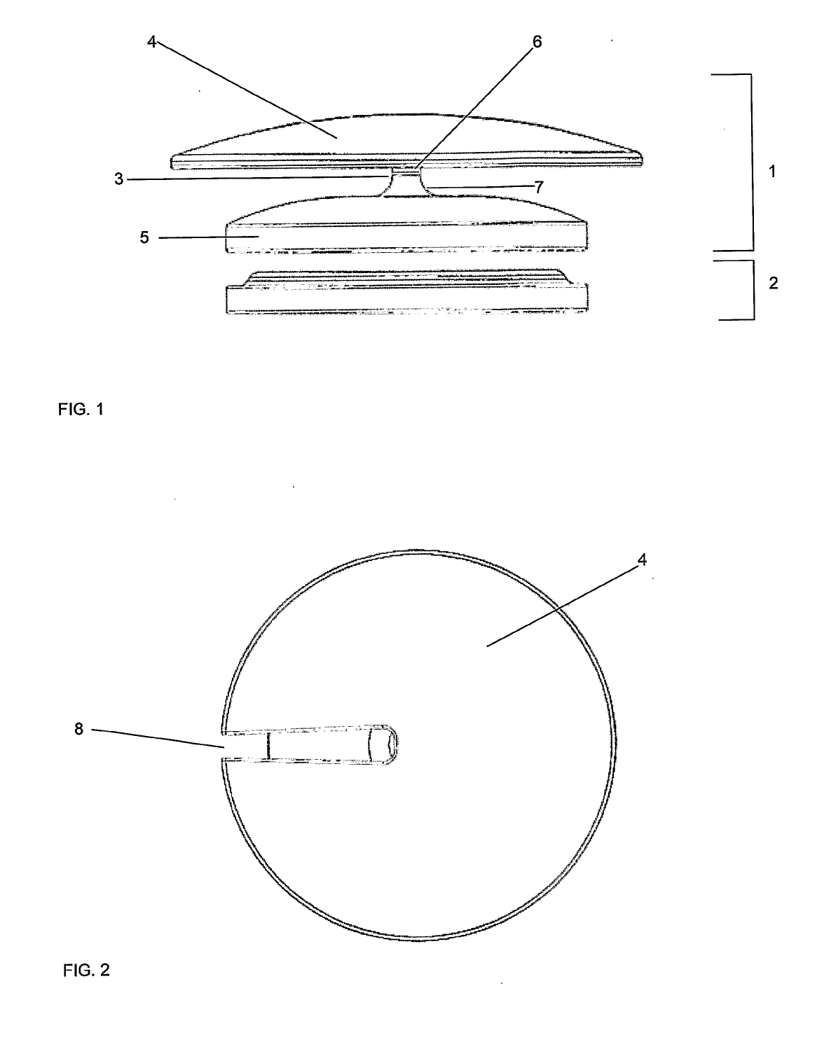

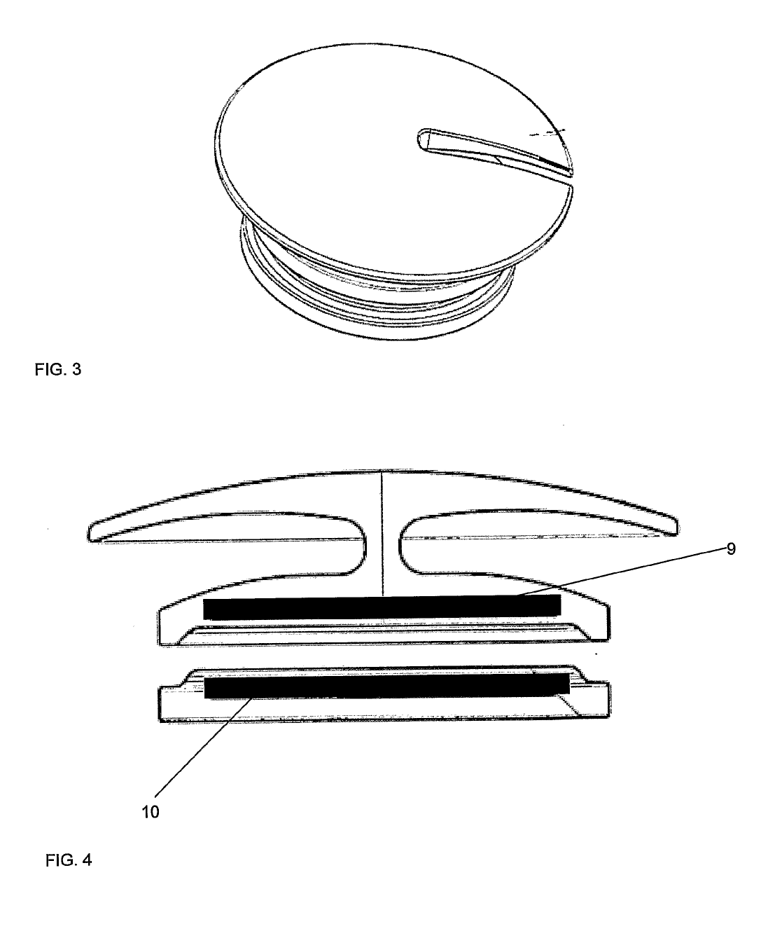

FIG. 1 discloses a cord adjustment device according to a specific embodiment of the present invention showing a spool shaped member 1 and the mating member 2. The spool shaped member further comprises a central axial portion 3, a front portion 4 and a back portion 5. The central axial portion 3 has a first/front distal end 6 and a second/back distal end 7. The front portion extends of the first distal end of the central axial portion having a larger circumference than the central axial portion, and a back portion extending of the back/second distal end of the central axial portion 3 having a larger circumference than the central axial portion 3. The shape of the device is such that a cord can be “enwrapped” around the central axial portion 3 of the spool member 1 between the front 4 and the back portion 5 and a slot 8 is formed in the front portion 4 to receive the cord after it has been enwrapped around the central axial portion 3 and fasten. The device is further characterised in that the back portion 5 further comprises a magnetic materiel to attach said spool member 1 to a magnetic surface. In the embodiment shown in FIG. 1, the cross section or circumference of the front portion 4 is larger than the back portion 5. It also shows how the cross section or circumference of the central axial portion 3 is much smaller than the front 4 and back portion 5 of the spool member 1, allowing the cord to be wrapped around the central axial portion 3 several times. FIG. 2 shows the slot 8 in the front portion of the spool member 1.

FIG. 4 shows a cross-section of the device of the present invention, showing the spool shaped member 1 and the mating member 2. The spool shaped member further comprises a first compartment 9 in the back portion 5, housing a magnetic material. In the same manner a second compartment 10 in the mating member 5, comprises a magnetic material to create a magnetic attraction between the spool member and the mating member.

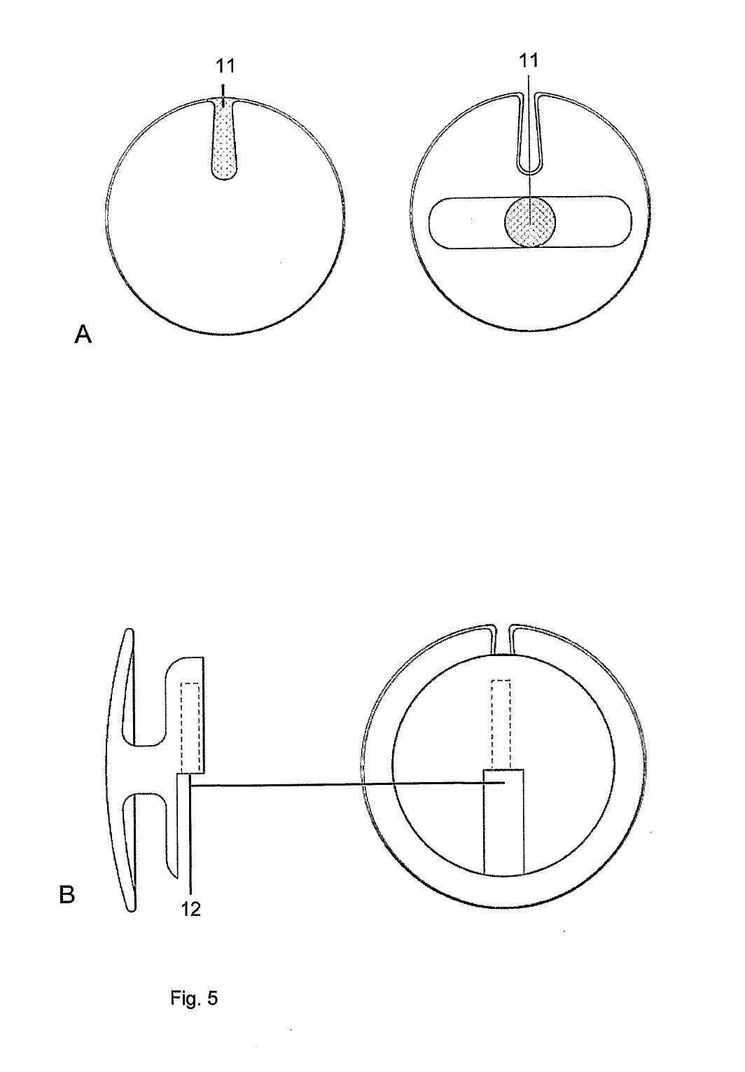

FIG. 5 a shows two different modifications of the cord adjustment device according to the present invention, where a microphone (11) has been positioned in the front portion (4) of the device. In the first version (A) the microphone has been placed in the slot (8) of the front portion (4), whereas in the second version (B) the microphone has been placed in the centre of the front portion (4).

FIG. 5 b shows an embodiment of the present invention where a mini-jack (12) has been introduced in the back portion (5) of the device.

1. Cord adjustment device comprising:
a spool member, the spool member further comprising:
a central axial portion having a first distal end and a second distal end,
a front portion extending of the first distal end of the central axial portion having a larger circumference than the central axial portion, and
a back portion extending of the second distal end of the central axial portion having a larger circumference than the central axial portion,
wherein a slot is formed in the front portion to receive the cord after it has been enwrapped around the central portion and fasten, and
wherein the back portion further comprises a magnetic material to attach said spool member to a magnetic surface.

2. The cord adjustment device according to claim 1, wherein the cord adjustment device further comprises a mating member comprising a magnetic material, configured to mate with the magnetic back portion.

3. The cord adjustment device according to claim 1, wherein the back portion of the spool member comprises a ferromagnetic material.

4. The cord adjustment device according to claim 2, wherein the mating member comprises a ferromagnetic material.

5. The cord adjustment device according to claim 1, wherein the spool member further comprises a cover portion which can be attached and detached from the front portion of the spool member.

6. The cord adjustment device according to claim 5, wherein the cover portion is made from transparent material.

7. The cord adjustment device according to claim 5, wherein the front portion is labeled.

8. The cord adjustment device according to claim 1, wherein the front portion comprises an additional slot to receive the cable before wrapping.

9. The cord adjustment device according to claim 1, wherein the device is dimensioned and configured for use with an earphone cord of portable media devices.

10. The cord adjustment device according to claim 9, wherein the media device comprises at least one of an mp3 player, compact disc player, portable DVD player, and iPOD.

11. The cord adjustment device according to claim 1, wherein the device is dimensioned and configured for use with an earphone cord of portable telecommunication devices.

12. The cord adjustment device according to claim 1, wherein the device further comprises a microphone.

13. The cord adjustment device according to claim 1, wherein the device further comprises a plug.

14. The cord adjustment device according to claim 1, wherein the device further comprises a transmitter unit and/or a receiver unit.

15. A communication device for attaching to clothing or any textile, the device comprising:
a spool member, the spool member further comprising:
a central axial portion having a first distal end and a second distal end,
a front portion extending of the first distal end of the central axial portion having a larger circumference than the central axial portion, and
a back portion extending of the second distal end of the central axial portion having a larger circumference than the central axial portion,
wherein the back portion further comprises a magnetic materiel to attach said spool member to a magnetic surface and wherein the device further comprises a mating member comprising a magnetic material, configured to mate with the magnetic back portion.

16. The communication device according to claim 15, wherein a cord can be “enwrapped” around the central portion of the spool member and wherein a slot is formed in the front member to receive the cord after it has been enwrapped around the central portion and fasten.

17. The communication device according to claim 15, wherein the front portion or the back portion of the spool member comprises a ferromagnetic materiel.

18. The communication device according to claim 15, wherein the device further comprises a microphone.

19. The communication device according to claim 15, wherein the device further comprises a plug.

20. The communication device according to claim 15, wherein the device further comprises a transmitter unit and/or a receiver unit.

21. The cord adjustment device according to claim 15, where the device further comprises an audio player.
